(19) United States
(12) Patent Application Publication
(10) Pub. No.: US 2017/0173473 A1
(43) Pub. Date: Jun. 22, 2017

(54) APPARATUS AND METHOD FOR AUTOMATICALLY GENERATING SCENERY

(71) Applicant: Crytek GmbH, Frankfurt am Main (DE)

(72) Inventor: Fatih Özbayram, Frankfurt am Main (DE)

(73) Assignee: Crytek GmbH, Frankfurt am Main (DE)

(21) Appl. No.: 14/971,918

(22) Filed: Dec. 16, 2015

(51) Int. Cl. A63F 13/79

(52) U.S. Cl. CPC A63F 13/79

(57) ABSTRACT

The present disclosure relates to an apparatus for automatically generating scenery in a computer-implemented game when played by a user. The apparatus comprises an identification module configured to identify the user, an access module configured to access a database to retrieve data characterizing the user, and a generation module configured to generate said scenery based on the data.

### TECHNICAL FIELD

The present disclosure relates to an apparatus and a method for automatically generating scenery in a computing environment and, in particular, in computer-implemented games when played by a user and, more particularly, to interest-based game worlds.

### BACKGROUND

There is an increasing demand for personalization within computing environments, such as game worlds. Although there are conventional computing environments that allow a user to personalize the environment to the user's own preferences, the corresponding procedure can be tedious and most users are not willing to perform a lengthy customization before starting with the exemplary computer games.

The exemplary computer games are generally designed according to a design brief. This results in a game produced with a pre-defined game world. As such, there is no opportunity for the players to have any personal influence over the game world in which they play. However, many players wish to have more influence in designing a game so that players could be able to influence their game world using their own personal interests, preferences and/or check-ins and to also put context to those parameters and hence the game world.

Unfortunately, most conventional systems are not able to generate, for example, a game world, which would fit automatically the demands of the various different users. This is not straightforward to implement, because the system is not aware of the preferences of a user. Therefore, most systems can only provide a customization based on data provided by the user credentials or other data that are not related to user interests.

Therefore, there is a demand for a system that enables improvements in the personalization of computing environments.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure solves the afore-mentioned problem by providing an apparatus, a method, and a computer program product according to independent claims. The dependent claims refer to specifically advantageous realizations of the subject matter of the independent claims.

The present disclosure relates to an apparatus for automatically generating scenery in a computer-implemented game when played by a user. The apparatus comprises an identification module configured to identify the user, an access module configured to access a database to retrieve data characterizing the user, and a generation module configured to generate the scenery based on the data.

The modules may be implemented in software running on a system that hosts the computer-implemented game. The database may or may not be stored in the computer system running the game. It may be possible that the database is stored at a remote location to which the computer system has access. The identification of the user may, for example, be performed upon login of the user in the computer system and the generation module may generate the scenery automatically without further user input.

According to yet another embodiment the generation module is configured to fill parts of the scenery in correspondence to data characterizing at least one of the following: at least one interest of the user, at least one preference of the user, a country where the user plays the game, geographical data characterizing an area of living of the user. Hence, based on the particular data stored in the database, the system may pre-populate the game world with assets adapted to the player's interests or preferences. Conventional systems were unable to determine automatically the preferences of different users and hence relied on a personalization procedure to be performed by the user before starting the application.

To implement the generation of the scenery the computing environment (i.e., exemplary game) may have blank assets, which are made available for customization. The number of available assets may depend on the level reached in the computer game. Therefore, the generation module may further be configured to generate the scenery comprising at least one of the following parts: a background of the game, at least one predefined area in the game, weather conditions during the game play, a seasonal background, a landscape depicted in the game, etc. The predefined areas may be any kind of portions or blank assets in the game that are not directly linked to the action in the game such as empty walls, form/shape of houses, advertising places, type of cars or restaurants, etc.

The scenery may also include iconic landmarks of a geographical region where the user lives or that the user is interested in. The scenery may likewise be adjusted in accordance to a particular time of the year. For example, during wintertime the scenery may include a snow-covered landscape and during summer a green landscape.

According to yet another embodiment the access module may be configured to retrieve prearranged content from the database as data characterizing the user. The generation module may be configured to combine multiple items of predetermined or prearranged content. The database may associate the keywords characterizing the user with the prearranged content. The prearranged content may be retrieved from a database to generate the scenery in the generation module. Furthermore, at least some keywords can be weighted keywords to define a hierarchy of interests or preferences. Accordingly, the generation module may further be configured to prefer content associated with keywords of higher weight over content associated with keywords of lower weight.

According to yet another embodiment the database comprises a plurality of content items being prearranged by outside contributors (i.e., users that are not playing the game such as supporting users or producers or advertisers) and the generation module is configured to assemble a set of items based on the characterizing data of the user.

According to yet another embodiment, the apparatus may comprise a modification module. The modification module may be configured to receive input data from the user. The input data may comprise keywords characterizing interests or preferences of the user. The modification module may modify the data characterizing the user on the database based on input provided by the user.

Therefore, the modification module enables the user to adjust the set of keywords in order to enable the system to generate a different scenery. For example, the user can submit new or modified keywords, and may remove keywords from the list or change weights assigned to particular keywords. The modification module may also enable the user to control the amount of personalization made by the system.

In addition, the system may request further information about what kind of personalization or customization is to be performed. This may be done by showing the user a list of possible selections that can be made so that the user has further control over the customization performed by the system. Therefore, according to yet another embodiment, the apparatus further comprises a selection module configured to request a selection (to be made by the user) for customization of the game.

The system may enhance the degree of customization dependent on the level reached by the user within the computer-implemented game. For example, in a first level, only minor customization possibilities may be offered, but with further advancement of the user (i.e., reaching higher levels of the game) the system may enable a higher degree of customization. For example, the system may allow changing the attire of a user only after the user has reached a certain minimum level within the computer-implemented game. Hence, according to yet another embodiment the selection provided by the selection module depends on a level achieved by the user within the computer-implemented game to allow an increased level of customization with an increased level within the computer-implemented game. According to yet another embodiment the generation module may be configured to generate automatically (i.e., without user interaction) different levels of customization of the game, wherein the different levels increase with an advance of the game.

The scenery may comprise a plurality of portions (e.g., blank assets) available for personalization and the selection module may be configured to provide the user with a list of the portions. Upon a selection made by the user, the generation module may be configured to generate automatically the scenery for the selected portions. The list of portions may also be provided to the user at a startup of the computer-implemented game so that he or she is able to perform the personalization before starting the game. Therefore, the system may provide the user with the possibility of selecting which of the available blank assets are to be populated by the system and which are not.

The present disclosure relates also to a (non-virtual, that is, hardware-based) computer system with an apparatus as defined before, a logic, a memory for storing the database, and at least one user interface to allow user interaction with the system. In particular, the computer system may be any processing unit comprising one or more of the following hardware components: a processor, a non-volatile memory for storing the computer program, a data bus for transferring data between the non-volatile memory and the processor, and input/output interfaces for inputting and outputting data from/into the computer. This hardware may implement the described apparatus by installed software.

The present disclosure relates further to a method for automatically generating scenery in a computer-implemented game when played by a user. The method comprises identifying the user (e.g., upon login of the user), accessing a database to retrieve data characterizing the user, and (automatically) generating the scenery based on the data. In addition, all functions described previously in conjunction with the apparatus can be realized as further method steps and be implemented in software or software modules. This method may also be implemented in software or a (non-volatile) computer program product. Thus, the present disclosure relates also to a computer program product having program code stored thereon for performing the above-mentioned method, when the computer program is executed on a computer or processor. The computer program product may be a machine readable storage medium including program code, when executed, to cause a machine to perform one of the mentioned methods.

### BRIEF DESCRIPTION OF THE DRAWINGS

Various embodiments of the present disclosure will be described in the following by way of examples only, and with respect to the accompanying drawings, in which:

FIG. 1 depicts schematically an apparatus for automatically generating scenery;

FIG. 2 depicts an exemplary assignment of a list of keywords to prearranged content;

FIG. 3 depicts a computing device suitable to implement various embodiments of the present disclosure; and

FIG. 4 depicts a flowchart of a method according to the present disclosure.

### DETAILED DESCRIPTION

The present disclosure describes a method and a system that enables users (e.g., gamers or players) to control or at least to influence their own scenery (e.g., game worlds) through their personal interests, preferences and/or check-ins (e.g., the country or area where they are playing a game).

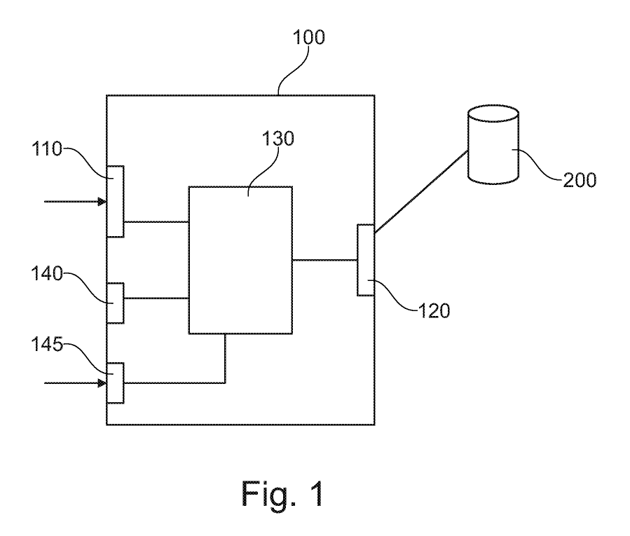

FIG. 1 depicts such a system or apparatus for automatically generating scenery in a computer-implemented game when played by a user. The apparatus 100 comprises an identification module 110 configured to identify the user, an access module 120 configured to access a database 200 to retrieve data characterizing the user, and a generation module 130 configured to generate the scenery based on the data. The identification of the user may be done upon login of the user and the generation of the scenery can be done without further user interaction, i.e., automatically upon starting the exemplary computer game.

Therefore, according to the present disclosure, the user is able to control the system in creating a user-specific environment by providing data to the system that characterizes the user itself. The interests may, for example, be organized in terms of keywords. The keywords can be user-specific or context-based to help to organize the database reflecting interests and preferences of the user. The apparatus may comprise an optional modification module 140 that enables the user to adjust a set of keywords in order to enable the system to generate different scenery. Furthermore, the apparatus may comprise an optional selection module 145 that enables the user to identify the assets that are to be subject to personalization, to select different prearranged content, a degree of customization or other options for selecting desired scenery.

The interests may, for example, comprise keywords such as “politics,” “news,” “local news,” “music,” “restaurants,” and more specific data related to which kind of restaurants and which kind of music is of particular interest to the user. In addition, the system may be configured to associate particular content to the data characterizing the user, wherein the particular content might be of interest to the user. For example, if the user would be interested in particular restaurants (for example, Japanese food), the system may create a game world having Japanese restaurants. The same applies to geographic data characterizing the user. For example, if the user lives in a particular country, the system may use landmarks of that country to create the game world. As a result, the system is able to automatically generate scenery of the computer-implemented game, wherein the user feels immediately comfortable.

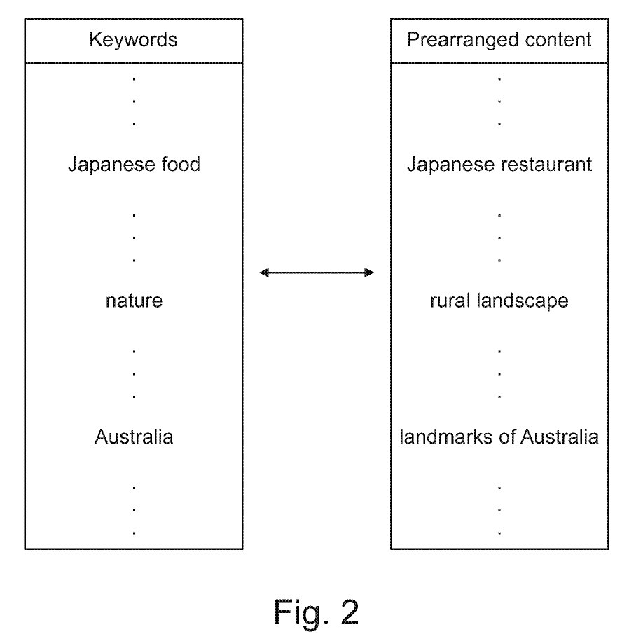

FIG. 2 depicts an exemplary assignment of stored keywords with prearranged content. The keywords may be provided by the user itself (e.g., using the modification module 140) or may be derived from data available at the system. For example, a keyword indicating the interest in Japanese food may be assigned to Japanese restaurants. As a result, Japanese restaurants can be distributed within the exemplary computer game. Similarly, if the user has interests in nature, the system may assign particular landscapes to be shown in the computer game (for example, rural landscapes). Finally, an interest in Australia may be assigned to Australian landmarks that can also be distributed within the game.

In addition, each keyword can be provided with a weight factor reflecting a degree of interest or indicating certain preferences of the user. Therefore, the prearranged content can be selected for display in the computer game based on the weight factors assigned to the keywords. For example, higher weight factors may correlate to a higher likelihood for showing the assigned content. Hence, the weighted keywords define a hierarchy of interests and preferences to indicate more important interests of the user than others. Hence, the system can flexibly adjust the database to particular needs and interests of various users by defining a network of keywords. Based on these keywords the system is able to organize the database within a structured hierarchy in that for one keyword (for example, “news”) several sub-keywords are assigned to specify which kinds of news are of particular relevance to the user.

Since the interests and preferences of the user are typically not unrelated, but depend on each other, the database may organize the characterizing data of the user as representing a network of keywords or a graph of keywords representing interconnected interests/preferences. Thus, it is understood that FIG. 2 depicts only the simplest possibility. In general, however, the keywords define a network of nodes and edges reflecting the interrelations of interests and preferences of a user. For example, food in general can be associated with Japanese food in particular. Moreover, an interest in traveling can be correlated to a particular interest in Australia, and so on.

In addition, the system may be configured to associate with each available keyword particular content that can be provided in the game world of the user (for example, particular cities of interest to the user). Hence, if the user logs into the game, the system automatically retrieves the respective content associated with the stored user-specific keywords to generate a game world. As a result, the user experiences a high level of personalization.

Of course, the level of customization performed by the system may depend on various factors. For example, the user may be allowed to add additional customized items at the login procedure. For this, the selection module 145 may provide the user with a selection of possible customizations for that particular computing environment. However, in other implementations, the user can also skip this procedure, because it is often desired by a user start the particular application quickly, instead of going through a lengthy customization procedure.

Moreover, when the user reaches a next level, the system may enhance the possibility of personalizing the scenery by providing the user with further, additional selections. The system may likewise automatically increase the level of personalization by enabling more assets (e.g., further items or portions in the exemplary computer game) for personalization. Thus, customizations may only be allowed or the level of customization increases once a player had reached a certain level within a game. This would introduce the element of challenge, increase competitiveness against fellow players or friends, etc.

In order to enable the customization of the scenery, the system may identify various areas or items within the exemplary computer-implemented game, which is made available for customization. For example, the different restaurants along a street, or particular landmarks in the background can be made available for customization. Also, geographical adaptations can be made available for customization. Thus, pre-defined areas and game assets within the game world could be set aside or created and thus allocated for customization or pre-population based on a player's interests, personal preferences, and/or by check-in. These areas or game assets could then populate at game start-up, and according to the personal interests, personal preferences or particular check-in of the player. For example, if a player or user checks in in France, the system could then populate areas of the game world with iconic landmarks such as the Eiffel Tower, the Palace of Versailles or the Arc de Triomphe. The customization could also extend to typical weather for a given region or at a given time of year.

The implementation of this setup may further depend on the game genre. For example, the expectation for a user in a shooter or combat game is different as compared to a racing game. Whereas, a game character or avatar wearing branded shoes may not be appropriate in a shooter or combat game, a similar level of customization through a player's interests, preferences or by check-in may be very appropriate in racing games.

Another option can be that blank assets are populated by the player after game start-up. It is of advantage to implement this while avoiding long delays so that the players are able to actually start playing the game without long delays. Another option would be for advertiser participation. For example, an advertiser provides a blank asset that populates depending on the players interests. Potentially, this could create revenue streams for the game publisher or producer.

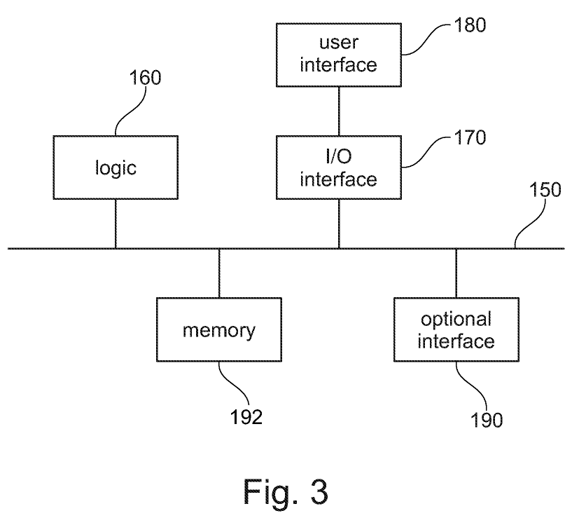

FIG. 3 depicts an example for a processing device for automatically generating scenery in a computer-implemented game when played by a user. The exemplary system may comprise the following hardware components: a memory 192, a logic 160 (for example, one or more processors), an I/O interface 170, a user interface 180 and further optional interfaces 190. An exemplary bus 150 may connect these components to transmit data and information between the components.

For example, the user interacts with the system over the user interface 180 (e.g., via a keyboard, touch screen, an acoustic interface, a display, etc.). The logic 160 is configured to implement the modules of FIG. 1, to access the memory 192 and to use the I/O interfaces 170 to interact with the user. The database 200 (FIG. 1) may also be stored remotely and the optional interface(s) 190 may include a network interface to enable an access of remote systems to retrieve data from the remote database. The memory 192 may, in particular, be a non-volatile memory as, for example, a hard drive or solid-state drive or a RAM-memory chip.

Hence, using the depicted system the user may use the user interface 180 to perform at least one of the following functions: add new keywords to the list of keywords, modify keywords, remove keywords from the list, adjust the weights assigned to particular keywords. In this way the system enables the user to control the amount of personalization. The system may also request further information about the kind or degree of personalization or customization that is to be performed. This may be implemented by showing the user a list of possible selections that can be made. Hence, the user has a high level of control over the customization performed by the system.

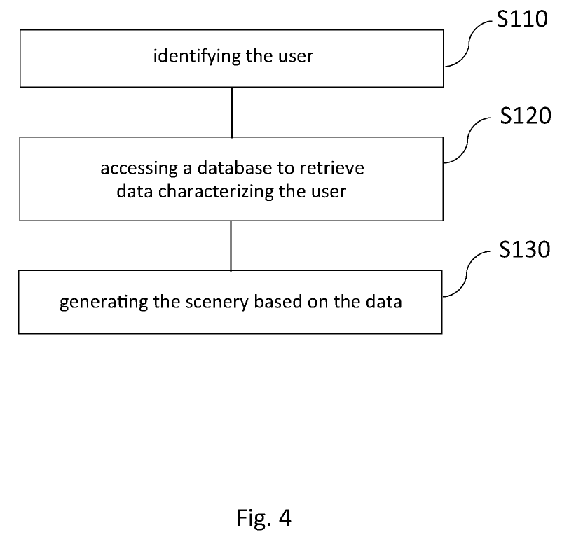

FIG. 4 depicts a flowchart of a method for automatically generating scenery in a computer-implemented game when played by the user. The method comprises identifying S110 the user (e.g., upon login of the user); accessing S120 a database to retrieve data characterizing the user; and generating S130 the scenery based on the data. The described method may be implemented on any kind of processing device. A person of ordinary skill in the art will readily appreciate that all above-described functions might be performed by programmed computers. Embodiments are also intended to cover program storage devices, e.g., digital data storage media, which are machine or computer readable and encode machine-executable or computer-executable programs of instructions, wherein the instructions perform some or all of the steps/functions of the above-described methods, when executed on the a computer or processor. The program storage devices may be, e.g., digital memories, magnetic storage media such as magnetic disks and magnetic tapes, hard drives, or optically readable digital data storage media. The examples are also intended to cover computers programmed to perform the steps of the above-described methods or (field) programmable logic arrays ((F)PLAs) or (field) programmable gate arrays ((F)PGAs), programmed to perform the steps of the above-described methods.

It is understood that functions of various elements shown in the figures may be provided through the use of dedicated hardware, such as “a signal provider,” “a signal processing unit,” “a processor,” “a controller,” etc., as well as hardware capable of executing software in association with appropriate software. Moreover, any entity described herein may correspond to or be implemented as “one or more modules,” “one or more devices,” “one or more units,” etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should further be understood that within the present disclosure the term “based on” includes all possible dependencies. For example, “a feature A being based on feature B” implies only that there are modifications of B that result in modifications of feature A. However, there may be other modifications of B that do not result in modifications in feature A.

The description and drawings merely illustrate the principles of the disclosure. It will thus be appreciated that those skilled in the art will be able to devise various arrangements that, although not explicitly described or shown herein, embody the principles of the disclosure and are included within its scope. Furthermore, it is intended to include also features of a claim to any other independent claim even if this claim is not directly made dependent to the independent claim.

While illustrative embodiments have been illustrated and described, it will be appreciated that various changes can be made therein without departing from the spirit and scope of the invention.

The embodiments of the invention in which an exclusive property or privilege is claimed are defined as follows:

1. An apparatus for automatically generating scenery in a computer-implemented game when played by a user, the apparatus comprising:
an identification module configured to identify said user;
an access module configured to access a database to retrieve data characterizing said user; and
a generation module configured to generate said scenery based on said data.

2. The apparatus of claim 1, wherein said generation module is configured to generate said scenery comprising at least one of the following: a background of said game, at least one predefined area in said game, weather conditions during game play, a seasonal background, and a landscape depicted in the game.

3. The apparatus according to claim 1, wherein said generation module is configured to fill parts of said scenery in correspondence to data characterizing at least one of the following: at least one interest of said user, at least one preference of said user, a country where said user plays said game, geographical data characterizing an area of living of said user.

4. The apparatus according to claim 1, wherein said access module is configured to retrieve prearranged content from said database as said data characterizing said user, and said generation module is configured to combine multiple items of prearranged content.

5. The apparatus according to claim 1, further comprising a modification module, the modification module being configured to receive input data from said user comprising keywords characterizing interests or preferences of said user and to modify said data characterizing said user on said database based on said input data provided by said user.

6. The apparatus according to claim 5, wherein said keywords comprise weighted keywords to define a hierarchy of interests or preferences, wherein said generation module is further configured to prefer content associated with keywords of higher weight over content associated with keywords of lower weight.

7. The apparatus according to claim 1, wherein said generation module is further configured to generate a level of customization of said computer-implemented game, which increases with an advance of said computer-implemented game.

8. The apparatus according to claim 1, further comprising a selection module, the selection module being configured to request from said user a selection for customization of said computer-implemented game.

9. The apparatus according to claim 8, wherein said selection depends on a level achieved by said user within said computer-implemented game to allow an increased level of customization with an increased level within said computer-implemented game.

10. The apparatus according to claim 8, wherein said scenery comprises a plurality of portions, wherein said selection module is configured to provide said user with a list of said portions and, upon a selection made by said user, the generation module is configured to generate automatically said scenery based on said selected portions.

11. The apparatus according to claim 10, wherein said list of portions is provided to said user at a startup of said computer-implemented game.

12. The apparatus according to claim 1, wherein said database comprises a plurality of content items being prearranged by outside contributors and said generation module is configured to assemble a set of items from said plurality of content items based on said data characterizing said user.

13. A computer system comprising:
an apparatus for automatically generating scenery in a computer-implemented game when played by a user, the apparatus comprising:
an identification module configured to identify said user;
an access module configured to access a database to retrieve data characterizing said user; and
a generation module configured to generate said scenery based on said data;
a logic;
a memory for storing said database; and
at least one user interface to allow user interaction with the computer system.

14. A method for automatically generating scenery in a computer-implemented game when played by a user, the method comprising:
identifying said user;
accessing a database to retrieve data characterizing said user; and
generating said scenery based on said data.

15. A computer program product having a program code stored thereon for performing a method for automatically generating scenery in a computer-implemented game when played by a user, when the computer program is executed on a computer, the method comprising:
identifying said user;
accessing a database to retrieve data characterizing said user; and
generating said scenery based on said data.
